(19) United States
(12) Patent Application Publication
(10) Pub. No.: US 2012/0273709 A1
(43) Pub. Date: Nov. 1, 2012

(54) Plastic Ball Valve Assembly

(75) Inventor: Lei Zhang, Tianjin (CN)

(73) Assignee: LINK-TECH (TIANJIN) METAL PRODUCTS CO., LTD.

(21) Appl. No.: 13/188,452

(22) Filed: Jul. 21, 2011

(30) Foreign Application Priority Data
Apr. 27, 2011 (CN) 201120127941.3

(51) Int. Cl. F16K 5/06

(52) U.S. Cl. 251/315.05

(57) ABSTRACT

A plastic ball valve assembly, includes a valve body part including a valve body made of plastic material and having a flow channel passing, a ball member having a through passage therein and rotatably located in the flow channel and a handle member, and a connecting part detachably connecting with the valve body part, including a pair of connecting caps engaged with the two ends of the valve body respectively, a pair of connecting heads made of different materials, each having a head made in different shapes. The multi-use ball is easy to be installed, reliable to be sealed, and strong in practicability.

### BACKGROUND OF THE PRESENT INVENTION

1. Field of Invention

The present invention relates to tools used in pipeline connection, and more particularly to a plastic ball valve assembly.

2. Description of Related Arts

At present, pipelines have been widely applied in industry, agriculture and urban construction, such as used in water supply and gas supply, etc. A ball valve in the pipeline is mainly used to cut off or distribute a media flow, or to change the direction of a media flow. Due to its compact structure, reliable sealing, easy operation and maintenance, the ball valve is comprehensively applied in various filed. In recent years, most of the ball valves which are have been widely used are metal ball valves (such as brass ball valve, stainless steel ball valve, etc.). However, for the rising price of copper and for the problem that using brass ball valve may cause lead in water pipeline and which is adverse to human health, people began to look for new materials to replace cooper to manufacture ball valve.

In addition, result from its structural limitation of the ball valve, one kind of ball valve body can only connect to one kind of tubes. Therefore, the prior art ball valves will increase production costs, and under the restrictions of the raw material and production method, the prior art ball valves can not meet the connection requirements of the pipelines with different materials.

Furthermore, in colder regions or seasons, the ball valve is easy to be frozen after it is closed, which leads to pipeline blockage and being difficult to open.

### SUMMARY OF THE PRESENT INVENTION

An object of the present invention is to provide a plastic ball valve assembly which has overcome the problems existed in prior art ball valves, meanwhile, the plastic ball valve assembly is simple in structure, convenient to discharge residual liquid in the ball, and strong in practicability.

Accordingly, in order to accomplish the above objects, the present invention provides a plastic ball valve assembly, comprising:

a valve body part, comprising a valve body having a flow channel passing through the inside of the valve body, a ball member having a through passage therein, wherein the ball member is rotatably located in the flow channel between an open condition which permits fluid flow through the flow channel and a closed condition which prevents fluid flow through the flow channel, and a handle member for switching the ball member between the open position and the closed position, wherein the valve body is made of plastic material, and

a connecting part detachably connecting with the valve body part, comprising a pair of connecting caps engaged with the two ends of the valve body respectively, a pair of connecting heads, wherein each connecting head has a head for connecting with the tube, wherein each connecting head is positioned between a connecting cap and the valve body, and each head passes through a connecting cap, wherein the connecting head is made of different materials, and the head of the connecting head is made in different shapes for matching different tubes,

wherein each end of the valve body has at least two recesses formed on the outer surface thereof, and each connecting cap has at least two projections matching with the recesses and provided on the inner surface of one end of the connecting cap, wherein the recesses of the valve body are engaged with the projections of the connecting caps,

wherein the recesses of the valve body are rotatably engaged with the projections of the connecting caps,

Alternatively, each connecting cap has inner threads formed on the inner surface of the connecting cap, wherein the connecting part further comprises a pair of connecting rings, each connecting ring has two notches aligned with each other on opposite sides of one end surface of the connecting ring, and outer threads formed on the outer surface of the connecting ring and matching with the inner threads of the connecting cap, wherein the recesses of the valve body is tightly engaged with the projections of the connecting caps, and each connecting ring is threadedly engaged with a connecting cap, and each head passes through a connecting ring.

Alternatively, the connecting part further comprises a pair of connecting rings, each connecting ring is interferentially connected with a connecting cap, and each head passes through a connecting ring.

Furthermore, the ball member has a drainage hole provide in the wall of the ball member at a position coaxial with the flow channel of the valve body when the through passage of the ball member is vertical to the flow channel of the valve body, and when the through passage of the ball member is coaxial with the flow channel of the valve body, the drainage hole is closed by the wall of the valve body and keeps in a sealed condition.

Furthermore, each connecting cap has an inside bevel provided on the inner surface of other end of the connecting cap.

Furthermore, each connecting cap has at least two gaps provided in the outer circumference of the connecting cap.

Therefore, the advantages and the benefit effects of the present invention are described as follows. Firstly, the valve body is made of plastic material, so as so avoid lead problem when using metal ball valves. Secondly, the connecting head of the plastic ball valve assembly is capable of connecting various tubes, so as to meet the connection requirements of the pipelines with different materials. Thirdly, due to the effect of the drainage hole, when the plastic ball valve assembly is closed, the residual liquid in the ball member is discharged through the drainage hole into the outlet pipe, so as to solve the problem that frozen residual liquid leads to blockage and being hard to open the plastic ball valve assembly. Also, the plastic ball valve assembly provided by the present invention is easy to be installed, reliable to be sealed, and strong in practicability.

### BRIEF DESCRIPTION OF THE DRAWINGS

FIG. 1 is a schematic view of a plastic ball valve assembly according to a first preferred embodiment of the present invention.

FIG. 2 is an exploded view of the FIG. 1.

FIG. 3 is a cross-sectional view of the FIG. 1.

FIG. 4 is a schematic view of the plastic ball valve assembly according to a second preferred embodiment of the present invention.

FIG. 5 is an exploded view of the FIG. 4.

FIG. 6 is a cross-sectional view of the FIG. 4.

FIG. 7 is a schematic view of the plastic ball valve assembly according to a third preferred embodiment of the present invention.

FIG. 8 is an exploded view of the FIG. 7.

FIG. 9 is a schematic view of the plastic ball valve assembly in use, showing the plastic ball valve assembly connecting with a plastic tube.

FIG. 10a is a schematic view of the plastic ball valve assembly with an inside bevel structure.

FIG. 10a is a schematic view of the plastic ball valve assembly with an inside bevel structure and gaps structure.

FIG. 11 is a schematic view of the plastic ball valve assembly according to a fourth preferred embodiment of the present invention.

1 valve body part; 11 valve body; 12 ball member; 13 valve stem; 14 threaded pressure ring; 15 handle member; 16 recess; 17 first seal ring; 18 gasket; 19 inside bevel; 20 gap; 2 connecting part; 21 connecting head; 22 connecting cap; 23 second seal ring; 24 projection; 25 notch; 26 inner threads; 27 outer threads; 28 connecting ring; 3 plastic tube; 4 drainage hole.

### DETAILED DESCRIPTION OF THE PREFERRED EMBODIMENT

A further disclosure of the present invention will be described in the following with reference to the drawings.

### First Embodiment

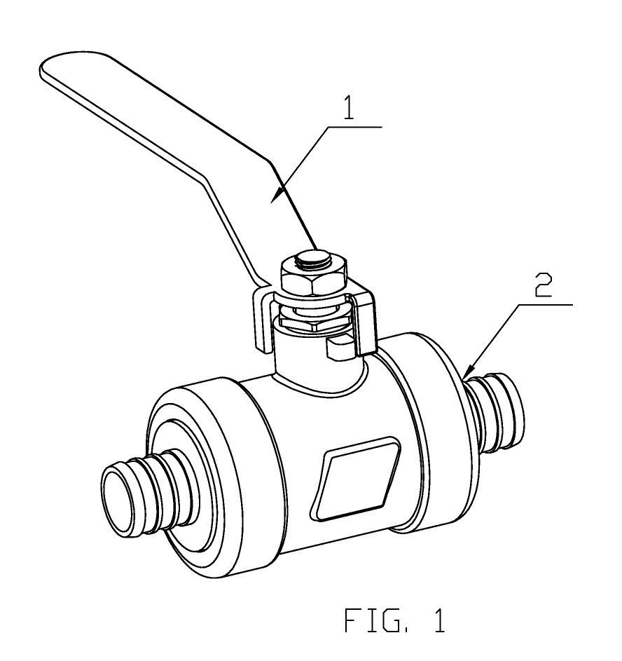

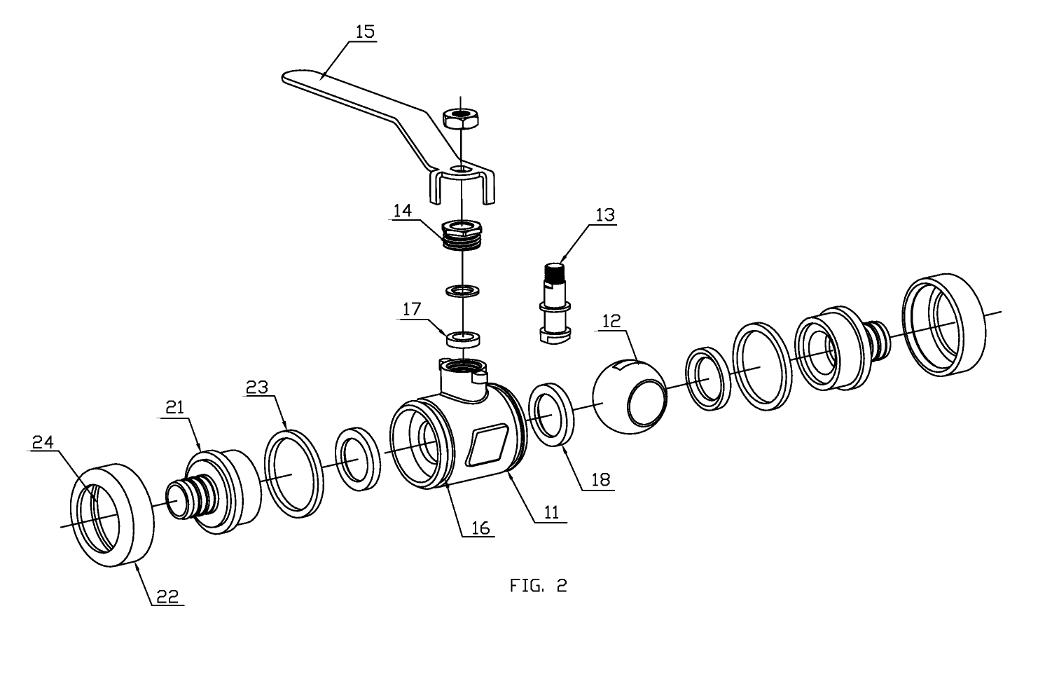

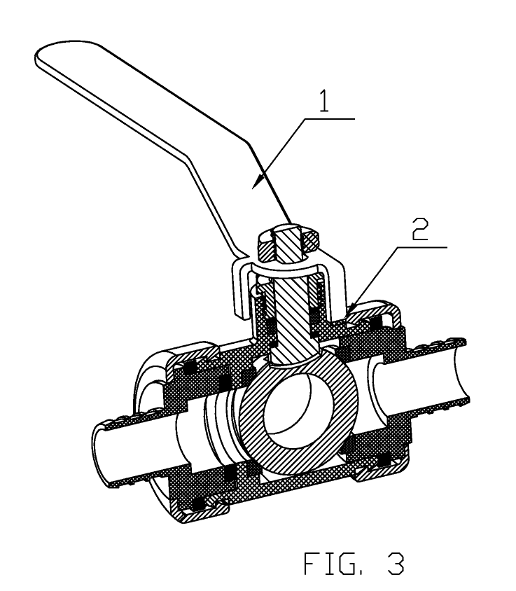

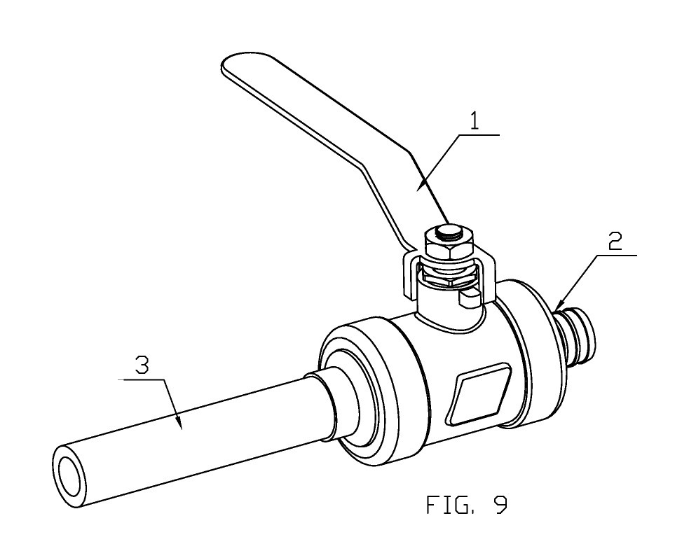

Referring to FIG. 1 to FIG. 3, FIG. 9 of the drawings, a plastic ball valve assembly comprises a valve body part 1 and a connecting part 2 adapted for detachably connecting to the valve body part 1. The valve body part 1 comprises a valve body 11 having a flow channel passing through the inside of the valve body 11, a ball member 12 has a through passage therein, a valve stem 13, a threaded pressure ring 14, a first seal ring 17, two gaskets 18, and a handle member 15. The valve body 11 has two ends, and each end has at least two recesses 16 formed on the outer surface thereof. The valve body 11 is made of plastic material.

The ball member 12 is rotatably located in the flow channel of the valve body 11 between an open condition which permits fluid flow through the flow channel and a closed condition which prevents fluid flow through the flow channel. When the plastic ball valve assembly is open, the ball member 12 at the open position, the through passage of the ball member 12 is coaxial with the flow channel of the valve body 11, and when the plastic ball valve assembly is closed, the ball member 12 at the closed position, the through passage of the ball member 12 is vertical to the flow channel of the valve body 11. The one end of the valve stem 13 having a threaded end threadedly engaged with the threaded pressure ring 14, and the other end of the valve stem 13 is connected with the ball member 12 for rotating the ball member 12. The first seal ring 17 is sleeved on valve stem 13 for sealing a seam between the valve stem 13 and the ball member 12. The handle member 15 is employed to switch the ball member 12 between the open position and the closed position. The handle member 15 is installed on top end of the threaded pressure ring 14 so as to rotate the valve stem 13 via the threaded pressure ring 14, and then to rotate the ball member 12. And the gaskets 18 are positioned on the two openings of the through passage of the ball member 12.

The connecting part 2 comprises a pair of connecting heads 21, a pair of connecting caps 22 and a pair of second seal rings 23, wherein each connecting cap 22 has at least two projection 24 matching with the recesses 16 and provided on the inner surface of one end of the connecting cap 22 for being engaged with the recesses 16 so as to avoid the connecting cap 22 getting loose. According to the first embodiment, the recesses 16 of the valve body 11 are rotatably engaged with the projections 24 of the connecting caps 22.

Each second seal ring 23 is sleeved on a connecting head 21 for seal connection. Each connecting head 21 has a head for connecting with the tube, wherein each connecting head 21 is positioned between a connecting cap 22 and the valve body 11, and the head passes through a connecting cap 22.

For facilitating the connection of the connecting head 21 to various tubes (such as PEX tube, PVC tube, copper tube, etc.), the connecting head 21 can be made of different materials, and the head of the connecting head 21 can be made in different shapes.

As shown in FIG. 9, a schematic view of the plastic ball valve assembly in use is illustrated, in which the plastic ball valve assembly is connected with a plastic tube 3.

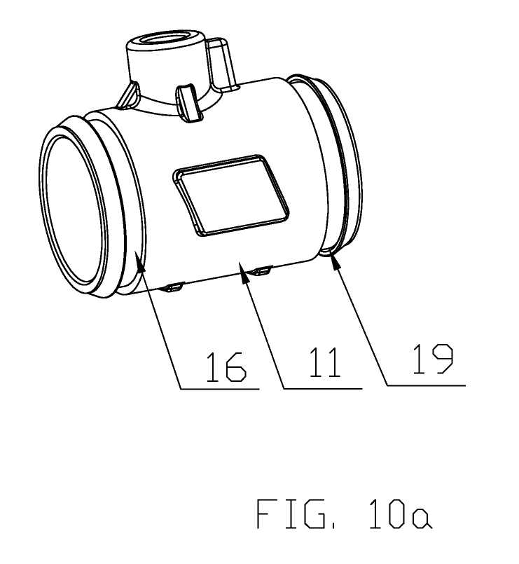

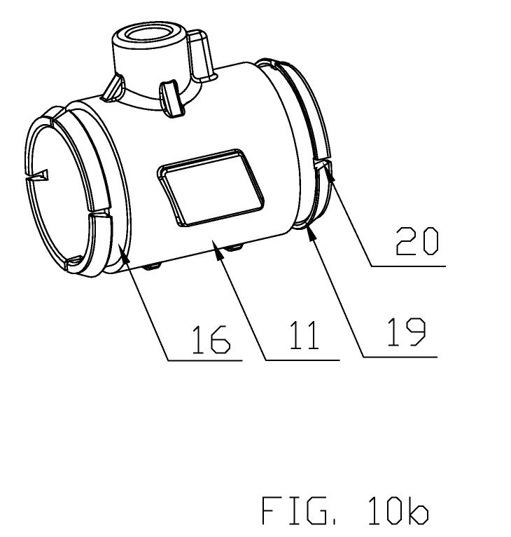

Furthermore, each connecting cap 22 has an inside bevel 19 provided on the inner surface of other end of the connecting cap 22, as shown in FIG. 10a.

Furthermore, each connecting cap 22 has at least two gaps 20 provided in the outer circumference of the connecting cap 22.

The inside bevels 19 and the gaps 20 are both have a role on preventing the abrasion between the connecting cap 22 and the valve body 11. When the connecting cap 22 is pressed to connect with the valve body 11, the protruding side edge of the valve body 11 will be abraded. With inside bevels 19 and/or gaps 20, there is a certain compression space provided. As the connecting cap 22 is pressing to connect with the valve body 11, the protruding side edge of the valve body 11 will inwardly contract for preventing abrasion from affecting the quality of the plastic ball valve assembly.

### Second Embodiment

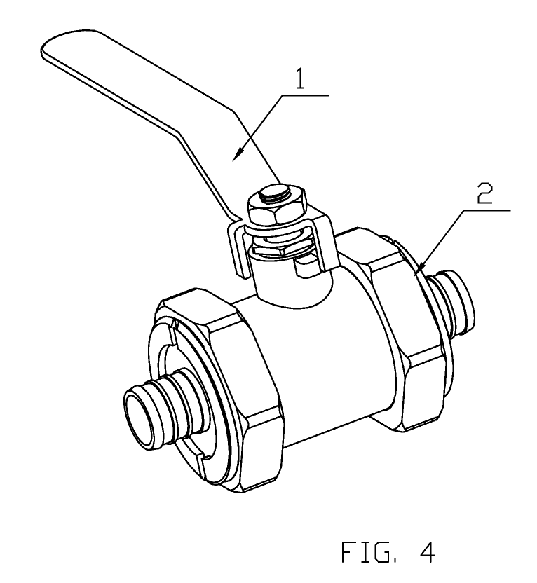

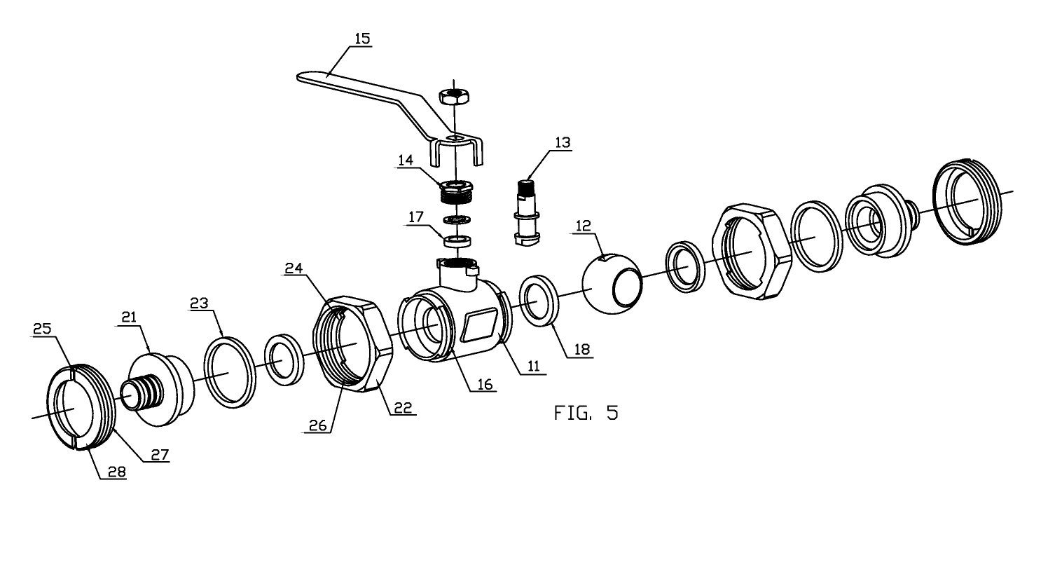

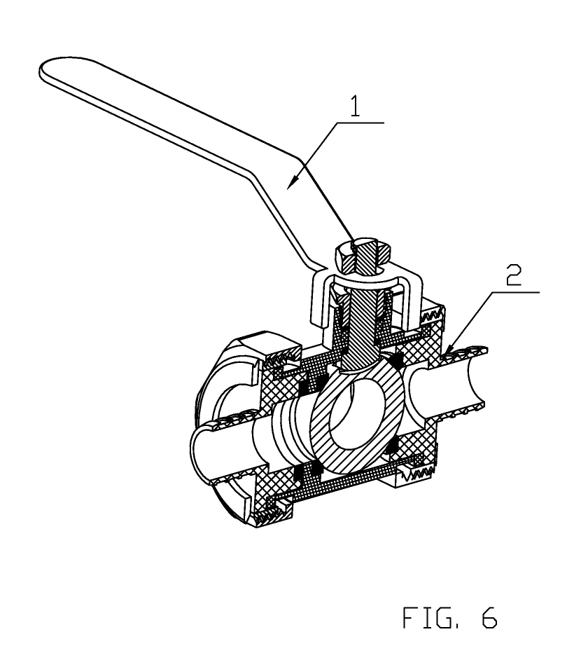

Referring to FIG. 4 to FIG. 6, FIG. 9 of the drawings, a plastic ball valve assembly comprises a valve body part 1 and a connecting part 2 adapted for detachably connecting to the valve body part 1. The valve body part 1 comprises a valve body 11 having a flow channel passing through the inside of the valve body 11, a ball member 12 has a through passage therein, a valve stem 13, a threaded pressure ring 14, a first seal ring 17, two gaskets 18, and a handle member 15. The valve body 11 has two ends, and each end has at least two recesses 16 formed on the outer surface thereof. The valve body 11 is made of plastic material.

The connecting part 2 comprises a pair of connecting heads 21, a pair of connecting caps 22 each having inner threads 26 formed on the inner surface of the connecting cap 22, a pair of connecting rings 28 and a pair of second seal rings 23, wherein each connecting ring 28 has two notches 25 aligned with each other on opposite sides of one end surface of the connecting ring 28, and outer threads 27 formed on the outer surface of the connecting ring 28 and matching with the inner threads 26 of the connecting cap 22. According to the second embodiment, each connecting cap 22 has at least two projections 24 matching with the recesses 16 and provided on the inner surface of one end of the connecting cap 22 for being engaged with the recesses 16 so as to avoid the connecting cap 22 getting loose. The recesses 16 of the valve body 11 are tightly engaged with the projections 24 of the connecting caps 22, meanwhile, the connecting rings 28 is threadedly engaged with the connecting caps 22. In this way, the connecting part 2 is connected with the valve body part 1.

Each connecting head 21 has a head for connecting with the tube, wherein each connecting head 21 is positioned between a connecting cap 22 and the valve body 11, and the head passes through a connecting cap 22. Each second seal ring 23 is sleeved on a connecting head 21 for seal connection. Each connecting ring 28 is threadedly engaged with a connecting cap 22, and each head passes through a connecting ring 28.

For facilitating the connection of the connecting head 21 to various tubes (such as PEX tube, PVC tube, copper tube, etc.), the connecting head 21 can be made of different materials, and the head of the connecting head 21 can be made in different shapes.

### Third Embodiment

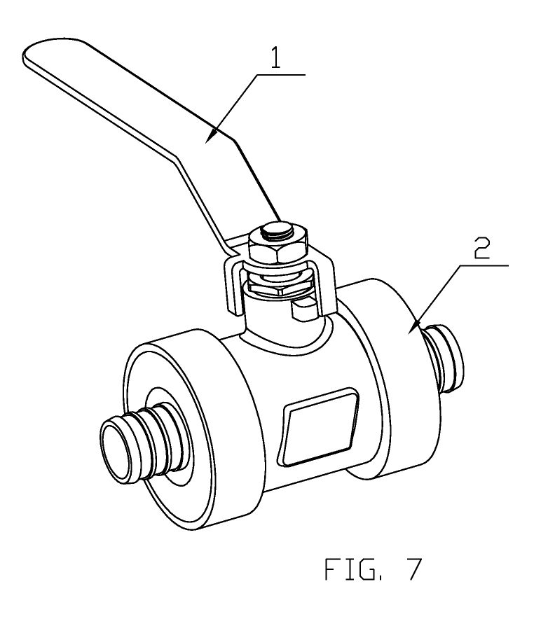

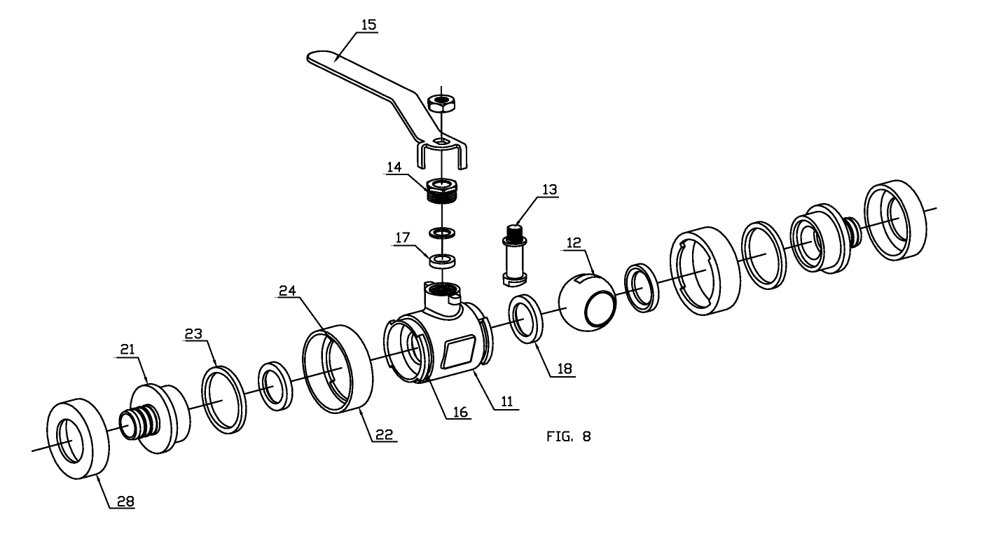

Referring to FIG. 7 to FIG. 9 of the drawings, a plastic ball valve assembly comprises a valve body part 1 and a connecting part 2 adapted for detachably connecting to the valve body part 1. The valve body part 1 comprises a valve body 11 having a flow channel passing through the inside of the valve body 11, a ball member 12 has a through passage therein, a valve stem 13, a threaded pressure ring 14, a first seal ring 17, two gaskets 18, and a handle member 15. The valve body 11 has two ends, and each end has at least two recesses 16 formed on the outer surface thereof. The valve body 11 is made of plastic material.

The connecting part 2 comprises a pair of connecting heads 21, a pair of connecting caps 22, a pair of connecting rings 28 and a pair of second seal rings 23. According to the third embodiment, each connecting cap 22 has at least two projection 24 matching with the recess 16 and provided on the inner surface of one end of the connecting cap 22 for being engaged with the recesses 16 so as to avoid the connecting cap 22 getting loose. The recesses 16 of the valve body 11 are tightly engaged with the projections 24 of the connecting caps 22, meanwhile, the connecting rings 28 are interferentially connected with the connecting caps 22.

Each connecting head 21 has a head for connecting with the tube, wherein each connecting head 21 is positioned between a connecting cap 22 and the valve body 11, and has a head passing through a connecting cap 22. Each second seal ring 23 is sleeved on a connecting head 21 for seal connection. Each connecting ring 28 is threadedly engaged with a connecting cap 22, and each head passes through a connecting ring 28.

For facilitating the connection of the connecting head 21 to various tubes (such as PEX tube, PVC tube, copper tube, etc.), the connecting head 21 can be made of different materials, and the head of the connecting head 21 can be made in different shapes.

### Fourth Embodiment

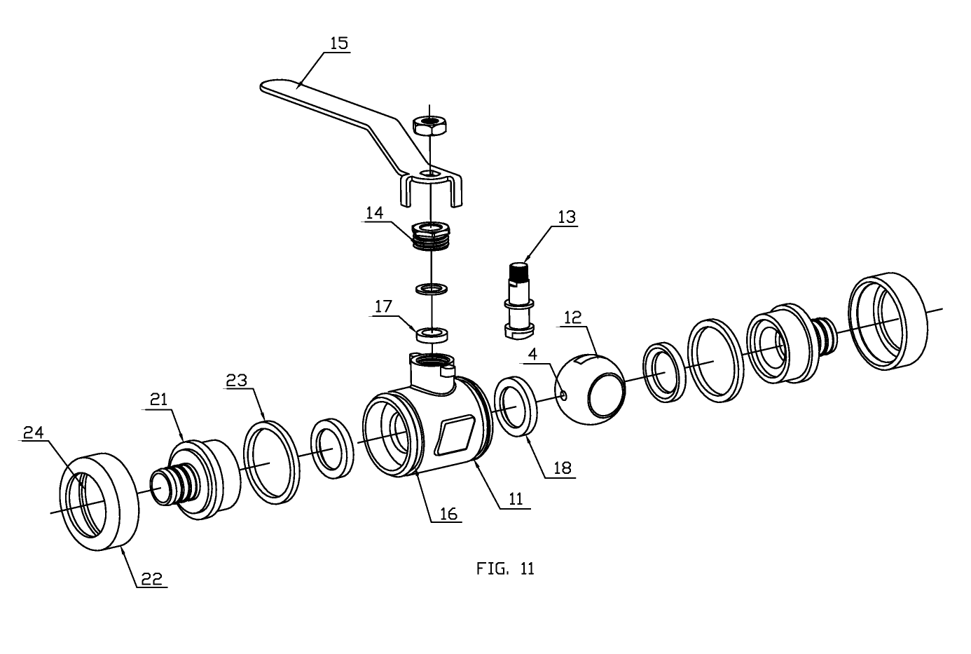

Referring to FIG. 9 and FIG. 11 of the drawings, a plastic ball valve assembly according to the fourth embodiment of the present is illustrated, in which the ball member 12 has a drainage hole 4 provide in the wall of the ball member 12 at a position coaxial with the flow channel of the valve body 11 when the through passage of the ball member 12 is vertical to the flow channel of the valve body 11, that is, the ball member 12 is at the closed position. When the plastic ball valve assembly is open, the ball member at the open position, the drainage hole 4 is closed by the wall of the valve body 11 and keeps in a sealed condition. And when the plastic ball valve assembly is closed, the through passage of the ball member 12 is closed to the outlet pipe while the drainage hole 4 is communicated to the outlet pipe, so that the residual liquid in the ball member 12 is discharged through the drainage hole 4 into the outlet pipe. In this way, the problems that the residual liquid becomes deteriorated so as to contaminate other liquid and it is hard to open the ball valve resulting from frozen residual liquid are both solved. Here, the drainage hole 4 can be a circular hole, a square hole or an oval hole.

Other elements and structures in the fourth embodiment are same to those in the first embodiment.

In the above embodiments of the present invention, the connecting head 21 is made of PEX material. However, the connecting head 21 is not limited to above material and structure. The connecting head 21 can be also made of PVC, copper, etc. and the head of the connecting head 21 may have inner threads or outer threads thereon, or be made in other shapes, so as to be connected with various tubes.

The head of the connecting head 21 may be straight-shaped or elbow-shaped.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A plastic ball valve assembly adapted for connecting with a tube, comprising:
a valve body part, comprising a valve body having a flow channel passing through the inside of the valve body, a ball member having a through passage therein, wherein the ball member is rotatably located in the flow channel between an open condition which permits fluid flow through the flow channel and a closed condition which prevents fluid flow through the flow channel, and a handle member for switching the ball member between the open position and the closed position, wherein the valve body is made of plastic material, and
a connecting part detachably connecting with the valve body part, comprising a pair of connecting caps engaged with the two ends of the valve body respectively, a pair of connecting heads, wherein each connecting head has a head for connecting with the tube, wherein each connecting head is positioned between a connecting cap and the valve body, and each head passes through a connecting cap, wherein the connecting head is made of different materials, and the head of the connecting head is made in different shapes for matching and connecting with different tubes.

2. The plastic ball valve assembly, as recited in claim 1, wherein each end of the valve body has at least two recesses formed on the outer surface thereof, and each connecting cap has at least two projections matching with the recesses and provided on the inner surface of one end of the connecting cap, wherein the recesses of the valve body are engaged with the projections of the connecting caps.

3. The plastic ball valve assembly, as recited in claim 2, wherein the connecting head is made of plastic material or metal material.

4. The plastic ball valve assembly, as recited in claim 3, wherein the head of the connecting head has inner threads or outer threads thereon.

5. The plastic ball valve assembly, as recited in claim 4, wherein the head of the connecting head is straight-shaped or elbow-shaped.

6. The plastic ball valve assembly, as recited in claim 5, wherein the recesses of the valve body are rotatably engaged with the projections of the connecting caps.

7. The plastic ball valve assembly, as recited in claim 5, wherein each connecting cap has inner threads formed on the inner surface of the connecting cap, wherein the connecting part further comprises a pair of connecting rings, each connecting ring has two notches aligned with each other on opposite sides of one end surface of the connecting ring, and outer threads formed on the outer surface of the connecting ring and matching with the inner threads of the connecting cap, wherein the recesses of the valve body is tightly engaged with the projections of the connecting caps, each connecting ring is threadedly engaged with a connecting cap, and each head passes through a connecting ring.

8. The plastic ball valve assembly, as recited in claim 5, wherein the connecting part further comprises a pair of connecting rings, each connecting ring is interferentially connected with a connecting cap, and each head passes through a connecting ring.

9. The plastic ball valve assembly, as recited in claim 6, wherein the ball member has a drainage hole provide in the wall of the ball member at a position coaxial with the flow channel of the valve body when the through passage of the ball member is vertical to the flow channel of the valve body, and when the through passage of the ball member is coaxial with the flow channel of the valve body, the drainage hole is closed by the wall of the valve body and keeps in a sealed condition.

10. The plastic ball valve assembly, as recited in claim 7, wherein the ball member has a drainage hole provide in the wall of the ball member at a position coaxial with the flow channel of the valve body when the through passage of the ball member is vertical to the flow channel of the valve body, and when the through passage of the ball member is coaxial with the flow channel of the valve body, the drainage hole is closed by the wall of the valve body and keeps in a sealed condition.

11. The plastic ball valve assembly, as recited in claim 8, wherein the ball member has a drainage hole provide in the wall of the ball member at a position coaxial with the flow channel of the valve body when the through passage of the ball member is vertical to the flow channel of the valve body, and when the through passage of the ball member is coaxial with the flow channel of the valve body, the drainage hole is closed by the wall of the valve body and keeps in a sealed condition.

12. The plastic ball valve assembly, as recited in claim 9, wherein the drainage hole is a circular hole, a square hole or an oval hole.

13. The plastic ball valve assembly, as recited in claim 10, wherein the drainage hole is a circular hole, a square hole or an oval hole.

14. The plastic ball valve assembly, as recited in claim 11, wherein the drainage hole is a circular hole, a square hole or an oval hole.

15. The plastic ball valve assembly, as recited in claim 6, wherein each connecting cap has an inside bevel provided on the inner surface of other end of the connecting cap.

16. The plastic ball valve assembly, as recited in claim 9, wherein each connecting cap has an inside bevel provided on the inner surface of other end of the connecting cap.

17. The plastic ball valve assembly, as recited in claim 6, wherein each connecting cap has at least two gaps provided in the outer circumference of the connecting cap.

18. The plastic ball valve assembly, as recited in claim 9, wherein each connecting cap has at least two gaps provided in the outer circumference of the connecting cap.

19. The plastic ball valve assembly, as recited in claim 15, wherein each connecting cap has at least two gaps provided in the outer circumference of the connecting cap.

20. The plastic ball valve assembly, as recited in claim 16, wherein each connecting cap has at least two gaps provided in the outer circumference of the connecting cap.
